(19) United States
(12) Patent Application Publication
(10) Pub. No.: US 2019/0026778 A1
(43) Pub. Date: Jan. 24, 2019

(54) Geographically Targeted Message Delivery Using Point-of-Sale Data

(71) Applicant: Acxiom Corporation, Conway, AR (US)

(72) Inventors: Mike Kuhl, San Diego, CA (US); Mike Gold, Lisle, IL (US); George L. Stephens, Fayetteville, AR (US); Scott Jones, Little Rock, AR (US)

(21) Appl. No.: 16/067,368

(22) PCT Filed: Dec. 19, 2016
(86) PCT No.: PCT/US16/67596

§ 371 Date: Jun. 29, 2018

Related U.S. Application Data
(60) Provisional application No. 62/273,778, filed on Dec. 31, 2015.

(51) Int. Cl. G06Q 30/02

(52) U.S. Cl. CPC G06Q 30/0261; G07G 1/14; G06Q 30/0255

(57) ABSTRACT

An apparatus and method for utilizing point-of-sale (POS) data containing geographical data, in conjunction with a consumer database containing consumer insights and propensities and privacy-compliant matching of off-line and on-line data capabilities, delivers a high-speed, targeted message to consumers associated with a particular geographic location. In certain implementations, syndicated data is used. Because the only data that is transferred to the retailer or other customer of the service for electronic messaging is the geographical area of the relevant consumers, the system maintains privacy while simultaneously providing a targeted, high-speed message to such consumers. Technical improvements and efficiencies reduce processing cycles, decrease the number of needed records, speed analytics through integrated systems, and enable action on a timely basis.

### TECHNICAL FIELD

This invention pertains to a method and system for utilizing point-of-sale (POS) and consumer data for delivery of messages targeted at a geographical level (such as, for example, by postal or ZIP code), which operates at a high speed to enable timely in-market message delivery in a privacy-compliant manner. The invention applies technical improvements and efficiencies to reduce processing cycles, decrease the number of records needed, speed analytics through integrated systems and enable action on a much more timely basis.

### BACKGROUND ART

Consumers are enjoying greater power and control than they have ever had prior to smart phones, widespread connectivity, and the ability to be “always on”. These realities make possible data, advertising and targeted delivery of advertising based on data. This, in turn, reduces noise, confusion, and increases brand awareness. As a result, consumers are now reaching a tipping point where they no longer want to be the subject of mass marketing—there are simply enough things vying for their attention during the day. They want a more granular level of choice over the marketing messages they receive. To achieve that, they are beginning to accept a quid pro quo with marketers—that there is value in offering up personal information in exchange for better information or more personalized offers. Their data is almost like another currency in that regard. As a result, the way marketing is happening is changing dramatically.

The delivery of electronic messaging—whether through web pages, text messages, cable television, or the like—has long been hampered by the inability to accurately target a message to a particular recipient or group of recipients. The result is mass advertising, which is inefficient and costly for the advertiser, and annoying to the consumer because the messages they view are often of no interest to them. The ability to target messaging to a particular viewer or group of viewers who are more likely to be interested in the message has long been understood as desirable, because it would reduce the cost to the party delivering the message, and would create a greater return on investment (ROI). Likewise, targeted messaging would benefit the consumer because the messages being viewed would more likely be of interest to the viewer, and the number of annoying, irrelevant messages that the viewer sees would be reduced.

One of the problems that has prevented the successful implementation of carefully targeted electronic messaging is the criticality of the timeliness of the message. A message that might be relevant at a particular point in time may become “stale” or irrelevant quickly. Trends in retail sales, for example, occur and then end more and more quickly in the modern world, and the ability to deliver a targeted message in response to the trend while it is still timely would be highly advantageous. Likewise, information that a particular consumer is “in market” for a product or class of products becomes stale quickly, and is useless to the marketer and annoying to the consumer if the message is sent after the consumer has already made the relevant purchase.

Another critical problem that has prevented the successful implementation of targeted electronic messaging is the importance of maintaining the privacy of the individual consumers to whom the messages are targeted. Various laws and best practices standards in the data industry require that no personally identifiable information (PII) concerning those persons who are receiving electronic messaging be made available to retailers or other customers of marketing services who are requesting the electronic messaging. Thus it would not do to provide to retailers all information concerning individuals who are to receive the on-line messaging as part of any targeted messaging solution. On the other hand, targeting of the messaging requires that some information be known about the individuals receiving the messaging in order for targeting to occur. Therefore, providing targeted messaging while maintaining anonymity of the message recipient with respect to the retailer is a difficult problem that has limited prior attempts to provide targeted electronic messaging.

Another challenge is that in the fields of retail, supplier, and consumer packaged goods (CPG), much of the available data is currently disparate. Data exists in siloes across multiple companies. This problem is compounded by the fact that marketing decisions are also siloed, because decisions are often made by multiple stakeholders across a company's organizational structure. The combined effect of this data and decision-making ecosystem is long decision cycles based on separate data repositories resulting in solutions that help the individual decision maker's area of responsibility, but not the retailer, supplier, or CPG as a whole. It may require weeks or even months to bring a marketing campaign with a targeted message to fruition. Thus a solution is desired to target messages to relevant consumers in a high-speed and privacy-complaint manner. Benefitting from fewer computing cycles, reduced record counts and integrated information systems, such a solution would result in reduced marketing expense when compared to mass marketing as is common practice today, and would alleviate the frustration of consumers subjected to mass marketing messages. Additionally, such a solution would greatly improve the results from the marketing message being delivered because of its targeted nature and timeliness.

### DISCLOSURE OF INVENTION

The present invention is directed to an apparatus and method for utilizing point-of-sale (POS) data containing geographical data (including, but not limited to, postal code data such as the United States Postal Service ZIP code information) in conjunction with a comprehensive consumer database containing consumer insights and propensities and the use of privacy-compliant matching of off-line and on-line data capabilities to deliver a high-speed, computationally efficient, targeted message to consumers associated with a particular geographic location. In certain implementations, syndicated data is used, that is, data that is pooled from numerous retailers by a third-party syndication service, including without limitation services provided by companies such as Nielsen, IRI, NPD, and APT. The invention solves the problem of providing the electronic messaging in a timely fashion to consumers who are most likely to find the message relevant. This is accomplished by using highly integrated and automated techniques, such as APIs, to bring zip-code-level insights from syndicated partners together with audiences from Acxiom within the target zip code. This allows campaigns to be executed, measured and consolidated into one easy to use and automated front-end software service maintained by the marketing data services provider delivering the targeted messages rapidly once the POS data is obtained. The invention also solves the problem of protecting the privacy of the viewer of the electronic message, since no PII concerning an individual is ever made available to the retailer or other customers for whom the targeted message is delivered. The result is that a retailer or other customer can deliver timely, targeted electronic messages to individual consumers in relevant geographic areas (such as, for example, persons within a certain postal or ZIP code) without compromising the private data of such persons, since the only data related to the consumer's identity provided to the retailer is the general geographic area (e.g., ZIP code) of the consumer. Furthermore, the retailer or other customer can utilize data concerning follow-up sales to gauge the effectiveness of the targeted electronic messages, thus creating a feedback loop that continues to improve the results and computing efficiency of subsequent marketing message campaigns.

More specifically, certain embodiments of the invention are directed to an apparatus and method that utilizes customer data or syndicated POS data relating to consumer packaged goods (CPG) or retail general merchandise. The information contains retail POS data containing tender types used in purchase from multiple retailers in contracted data-sharing partnerships with syndicated providers. Stock keeping units (SKUs), category, and market insights are delivered at a geographic level, and more specifically, at a postal or (in the United States) ZIP code level. This information is combined with consumer insights derived from a comprehensive consumer database, such as the Infobase database maintained by Acxiom Corporation, which includes deterministically matched propensity data (i.e., data pertaining to consumer propensities, such as an interest in particular sports or hobbies, or being “in market” for particular goods). Further, this data is utilized in connection with data “onboarding” capabilities, provided by companies such as Acxiom LiveRamp, whereby off-line sales data may be matched to on-line data about consumers in a privacy-compliant manner. This enables the targeted delivery of messages to consumers associated with the identified ZIP code of interest (or other geographical area). By using APIs to efficiently query large data sets of syndicated providers and narrowing the focus for action to limited zip codes with the greatest propensity to respond to advertising, this enables the retailer or supplier to capture trends in the marketplace as they are happening. (This is colloquially known as “moving at the speed of retail.”) The combination of syndicated POS data insights, the comprehensive consumer database insights, and onboarding capabilities creates a synergistic effect that allows the solution to provide value to the deliverer of the messages that is greater than the value of the individual parts. The invention facilitates decisions and actions by merchandisers (including, for example, buyers and category management professionals) within retailers and suppliers, or CPG companies, as particular non-exclusive customer examples. The invention ensures that the privacy of on-line consumers is maintained because the only data being passed between syndicated providers and the data services provider are the geographic indicators, for example, ZIP codes. A ZIP code alone is of course insufficient to identify a particular person, and thus does not, standing alone, constitute PII. The complete solution greatly increases the efficiency of the delivery of marketing messages over mass marketing because a reduced population of individuals is targeted, e.g., a particular ZIP code of interest. The result is reduced waste and expense of computing and other resources for the deliverer of the electronic messaging, such as a retailer, supplier, or CPG manufacturer, to drive the same or even greater results from the messaging. The deliverer of the messaging also will be able to perform more insightful analysis of a particular electronic message performance, including multi-level reporting and ROI data for each electronic message delivered. This analysis results in a feedback loop that allows subsequent marketing message campaigns to be even more targeted and effective thus driving even further resource efficiencies to include the computing environment.

These and other features, objects and advantages of the present invention will become better understood from a consideration of the following detailed description of the preferred embodiments and appended claims in conjunction with the drawings as described following:

### BRIEF DESCRIPTION OF DRAWINGS

FIG. 1 is a high-level architectural view of an implementation of the invention.

FIG. 2 is an alternative high-level architectural view of an implementation of the invention.

FIG. 3 is a high-level data flow “swim lane” diagram of an implementation of the invention.

FIG. 4 is an overview of a retail insights solution (RIS) selection process according to an implementation of the invention.

FIG. 5 is an overview of an RIS execution process according to an implementation of the invention.

FIG. 6 is an overview of an RIS insights/feedback process according to an implementation of the invention.

FIG. 7 is an overview of the point of sale (POS) aggregator data ingestion process according to an implementation of the invention.

### BEST MODE FOR CARRYING OUT THE INVENTION

Before the present invention is described in further detail, it should be understood that the invention is not limited to the particular embodiments and implementations described herein, and that the terms used in describing the particular embodiments and implementations are for the purpose of describing those particular embodiments and implementations only, and are not intended to be limiting, since the scope of the present invention will be limited solely by the claims.

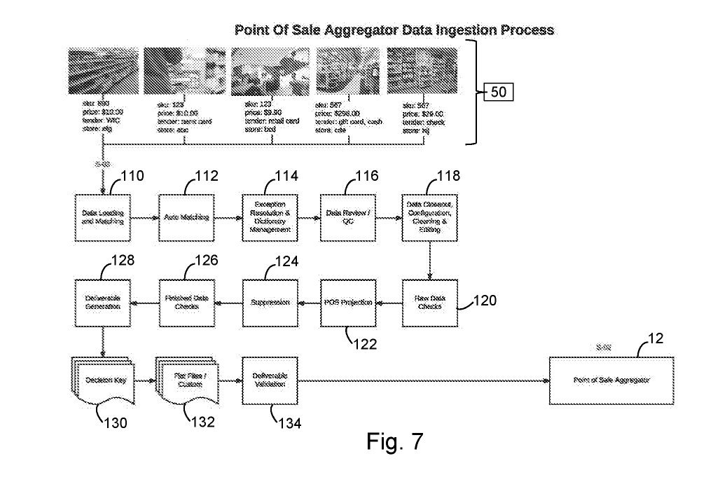

In certain embodiments, the invention is a retail insights solution (RIS) implemented, in overview, utilizing a software front-end maintained by a marketing data services provider on its internal servers, which allows the data to exist in its partner company's control and be queried when requested by a customer over a communications network, such as the Internet. The data itself is not viewable by or deliverable to partner companies in order to ensure privacy. The result of the query allows the front-end software to deliver geographic data, such as ZIP codes, to the data services provider from the syndicated partner companies. These ZIP codes determine the look-up parameters in the comprehensive consumer database maintained by the data services provider, thus determining the appropriate audience within the identified ZIP code based on propensity data. This audience is then delivered to the onboarding service to create the electronic messaging for delivery. Point of sale (POS) data is a key input to the RIS process and informs the ability to link POS SKU-level activity to a specific ZIP code. This data is provided, in certain embodiments, by a third-party collaboration partner. (The collection flow is described below in greater detail with reference to FIG. 7.)

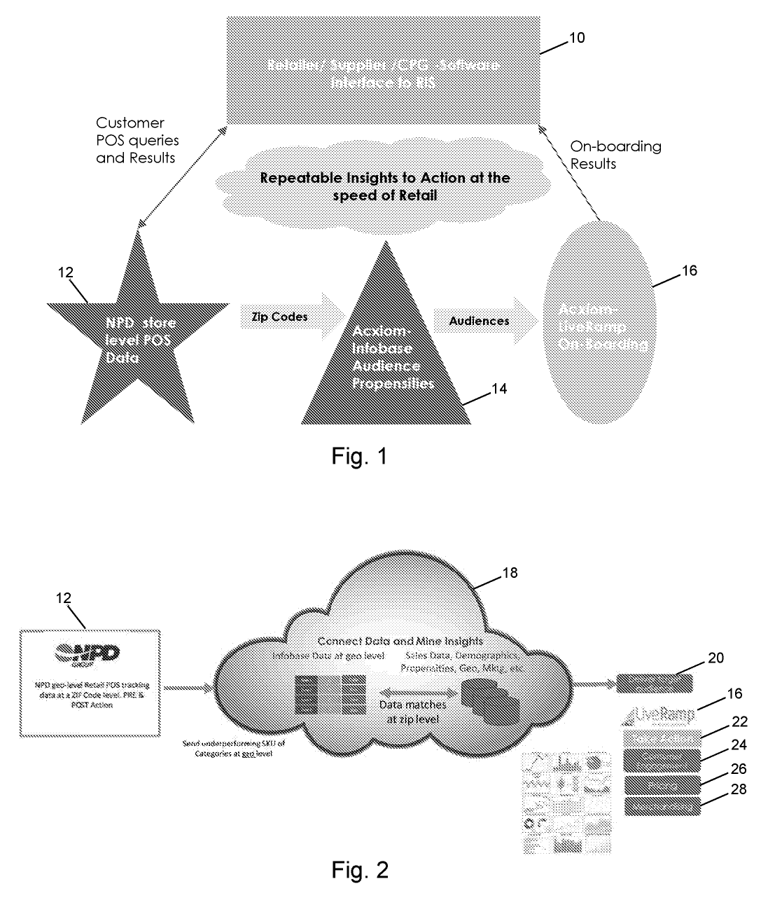

Turning now to FIG. 1, an embodiment of the invention may be described in more detail with reference to the high-level architectural diagram. The retailer/supplier/CPG software interface block (graphically represented by the rectangle 10) represents the software that, executing on a computer processor or processors at the data services provider, acts as a customer interface for the system. It allows disjointed data and decision-making processes that currently can require months of time to instead be performed in a rapid and efficient manner. For example, the transformation of insights to action may be reduced to days or even hours versus months with current methods, thus allowing the invention to operate at the “speed of retail” as described above. The interface provides a mechanism to query syndicated data from providers of this data for insights at a ZIP code level, and deliver ZIP codes to the comprehensive consumer database (in this case, the Infobase database maintained by Acxiom Corporation). This is performed in a privacy-compliant manner not visible to the customer. The Infobase database takes the ZIP codes and sorts data in order to enable the creation of an audience in the given ZIP codes for the desired electronic messaging. The interface then delivers audiences from the Infobase database to the onboarding software and hardware, in this case the LiveRamp onboarding system. A report may then be generated that provides, for example, the percentage of a desired audience to whom the electronic messages are delivered.

Store-level POS data aggregator (represented by the star in FIG. 1 and reference numeral 12) represents the data that drives the beginning of this process. It is maintained on computer servers operated by the aggregator service provider. It is derived from retail partners of the syndicator, and is identified by store location. Providers of this information, such as a firm by the name of NPD, develop industry-specific syndicated data with designated market area (DMA) attributes from aggregate retailer sales data. The DMAs from the syndicator are aligned with the retailer's divisional trade areas, such as provided through the category management association (CMA). The syndicator identifies “opportunity” trade areas, and translates those from the CMA system to ZIP codes in one embodiment. Those CMA ZIP codes are then transmitted to the comprehensive consumer database for further processing.

At the comprehensive consumer database 14 (in this case, represented by the pyramid in FIG. 1 as the Acxiom Corporation Infobase database and Infobase Audience Propensities sub-database), the data services provider compiles demographic and lifestyle data elements for individual consumers. Infobase contains a substantially comprehensive database of all individual consumers and households in a particular geographical region, such as the United States. This is performed in a privacy-compliant manner, since all processing takes place internally to the data services provider. The data services provider receives opportunity ZIP codes from the syndicator, and compiles from all of this prior processing the target audience portrait, i.e., a set of characteristics that describe the targeted audience for the messaging.

At the onboarding service 16 (in this case, represented by the oval in FIG. 1 as the LiveRamp onboarding service), disparate marketing platforms are connected at the data layer. The data is anonymized by removing any personally identifiable information (PII), thereby ensuring privacy for those in the targeted audience. This consumer data is then matched to online devices associated with particular consumers, such as desktop computers, laptop computers, tablets, smartphones, set-top cable television boxes, and the like. Data segments are distributed to the customer's choice of marketing platforms, which can include any form of electronic or on-line digital messaging. It may be seen that by distributing data across the customer's marketing infrastructure, the problem of data being “siloed” (i.e., isolated within an organization at one department and thus unknown to other departments within the organization) is eliminated, and customers may be reached with relevant, targeted electronic messaging across multiple digital channels. Furthermore, the impact of the messaging may be accurately measured by tracking the performance of the messaging in terms of follow-up sales in a feedback loop. A separate database area (in one embodiment, the Safe Haven environment maintained by Acxiom Corporation) is used to protect client data and perform privacy-compliant matching. Privacy is ensured because no PII is allowed into the Safe Haven environment; a de-identification process removes all PII before matching occurs. As a result, data leaving the Safe Haven environment cannot be tied back to PII by the customer (retailer, etc.) or any other party.

The overall integrated, automated system may be seen to provide targeted electronic messages at a much greater speed than previous systems through the use of APIs, while maintaining the privacy of the target audience and improving the return on investment (ROI) for the customer. APIs allow syndicated data to stay within the Data owner's domain. Therefore, existing agreements with syndicated data partners clients are not in question. Additionally, data services provider data is also queried through API. The result is that both parties' data is secured in their individual domains. Only actionable insights, counts and results from the combination of syndicated data and Acxiom data are made visible to the customer.

The creation of a user interface (UI) and APIs that coordinate between the client, syndicated provider and data services provider will save compute cycles and reduce the amount of data that is transmitted between the three parties. The client will be able to see results of their selection instantly and perform real-time refinement of their selections, significantly reducing the number of manual handoffs between multiple people within an organization. This will allow the overall system to accomplish multiple iterations in less time than just one interaction without the technology. Conservatively, this could result in a 5×-10× reduction in compute cycles. The embodiment of the invention thus enables a time-relevant solution that would otherwise take so long as to deliver results that were no longer of any business relevance. Once the client has accomplished multiple iterations using the UI and APIs, the system can execute the campaign against the audience selected.

The UI and APIs allow the execution of the campaign to be on a targeted audience, which will reduce the amount of records that are processed through the private data area and campaign execution tool. The resulting narrower and more effective targeting can reduce the number of records by 30%-50% or more. In addition, comparing audiences over multiple iterations allows further refinement and reduction in the number of records.

The UI and APIs will also give measurement of each campaign in a faster manner. The system will give the user a faster feedback on a campaign's results because the campaign was done on a more targeted audience. The data services provider will process fewer response records thus saving time, storage, compute cycles and response time back to the client. This enables the prospect of reviewing measurement results within 24 hours of campaign completion vs. days or even weeks under prior circumstances. The ad provider (e.g., Facebook or other premium publisher) will be provided daily feedback of clicks and views. Additionally, sales lift is captured on a weekly basis by the syndicated provider. This represents an improvement in visibility from current monthly sales reporting. The results are shared in one location across Marketing, Merchandising and other disciplines within the customer's business. Additionally, the solution gives the potential for campaign feedback near real time, which in some instances would allow changes while in flight (i.e., during the ongoing campaign) instead of post campaign.

Another manner of visualizing the overall architecture of an implementation of the invention is provided in FIG. 2. Here, store-level POS aggregator data 12 feeds into cloud 18, which represents the data services provider more as a “black box” from the point of view of the customer. ZIP code based data is ingested at cloud 18 to perform audience propensity matching, and the output is a ZIP code based audience at output block 20. The onboarding service 16 receives this data, and passes it to the customer to take action at action block 22. These actions can be consumer engagement at customer engagement block 24, performing pricing computations at pricing computation block 26, or merchandising at merchandising block 28.

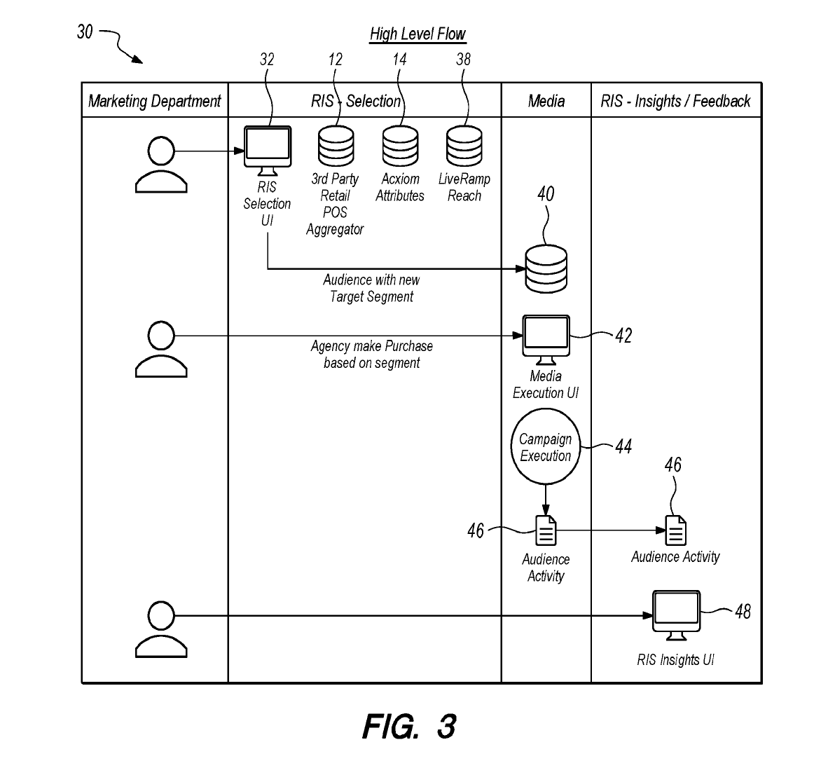

Referring now to the data flow “swim lane” chart of FIG. 3, an overview of an implementation of the invention may be provided with respect to the retail insight solution (RIS) selection and insights/feedback processes, which will be described in greater detail below. A marketing department 30 (consisting of one or more individuals) at a customer, such as a retailer, engages the system at RIS selection user interface (UI) 32. This software provides the front-end from the data services provider as described above. Data used in the RIS selection process includes third-party retail POS aggregator 12 data, attributes from the comprehensive consumer database 14 such as the Acxiom Infobase, and onboarding data 38 such as from LiveRamp. Processing using these data sources, as described above, results in an audience with a new target segment (by ZIP code, for example) at database 40. The marketing department 30 may then interact with the media execution UI 42 in order to begin a marketing message campaign. Campaign execution is represented at circle 44, which results in audience activity in report 46. This audience activity is used as an input to RIS insights UI 48, which may be accessed by marketing department 30 in order to understand the results and gain insights into the effectiveness of the marketing campaign. This allows a feedback loop where further message campaigns are informed by the results of previous campaigns, here again driving further resource conservation in the compute environment and other processes.

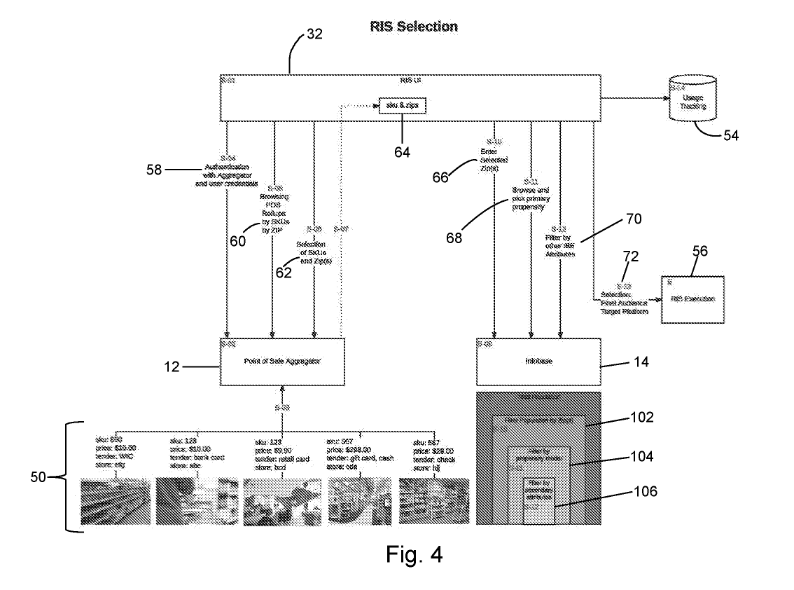

Referring now to FIG. 4, the RIS selection data flow may be described in greater detail. The customer (retailer, etc.) will utilize the RIS UI 32 to select the audience to which a marketing message will be sent. The two major steps are the selection of SKUs and ZIP codes from POS aggregator 12 and the selection of an audience using the comprehensive consumer database 14 based on the ZIP codes chosen. Specifically, RIS UI 32 allows the customer to browse the POS aggregator 12 data; narrow down the audience selection in the comprehensive customer database 14; start a campaign based on selection criteria from the comprehensive customer database 14; and view the results of the campaign.

The RIS begins by being able to use the POS aggregator 12 data to view a given product stock keeping unit (SKU) across regions and down to, for example, ZIP codes. The POS aggregator 12 pulls in retail data 50 from all of the stores that sell the product and gives manufacturers a view across retail chains. For each item, the POS aggregator 12 tracks, for example, the SKU for a particular retail item; the price for that item; the method of payment for that item; and the stores at which the item was sold. By using all of this information, the marketing department 30 can target, for example, underperforming ZIP code(s) or over-performing ZIP code(s), as desired according to the parameters of the messaging campaign.

The RIS UI 32 allows the customer to browse the data from POS aggregator 12. This action may be divided into four steps. The first step is authentication step 58, during which the customer signs into the RIS UI 32. A software-based user token may be used to authenticate against the POS aggregator 12. The user token will be used in all future API calls to the POS aggregator 12 system. Next, at browse step 60, the customer may browse the POS aggregator 12 data. This will allow the customer to narrow down the desired set of SKUs and ZIP codes. Then, at selection step 62, the customer selects the SKUs and ZIP codes that the customer is interested in targeting during this particular campaign. Finally, at recording step 64, the SKUs and ZIP codes selected by the customer are recorded in the usage-tracking database 54.

Following interaction with the POS aggregator 12 as just described, processing at the RIS UI 32 moves the customer to select an audience using the comprehensive consumer database 14. The RIS UI allows the customer to narrow down the audience by performing a series of steps. At data entry step 66, the ZIP codes and SKUs that were previously selected and storage at usage tracking database 54 are fed to comprehensive consumer database 14. Processing at comprehensive database 14 then is performed to narrow the population by ZIP codes at ZIP code filter step 102. This will narrow the universe of consumers that are of interest from the full universe of the comprehensive consumer database 14 (which may, for example, contain information on all consumers and households in a given region, such as the United States) to just individuals in the selected ZIP codes. Next, at pick primary propensity step 68, the customer is allowed to select the propensity model desired from a catalog of available propensity models (e.g., the propensity for purchasing small appliances from a mass merchant), the processing for which occurs at filter by propensity model step 104. A secondary filter may be used to pick the range within the propensity model. For example, the customer could select those consumers in the top 20% for a given model. At filter step 70, such other attributes from the comprehensive consumer database 14 may be used to narrow the audience at filter by secondary attributes step 106. For example, if the customer only wishes to target women for a given product/SKU, the customer can utilize the corresponding attribute from comprehensive consumer database 14 to pick only women. Finally, at trigger step 72, a campaign is triggered based on the selected audience count, and processing moves to RIS execution step 56.

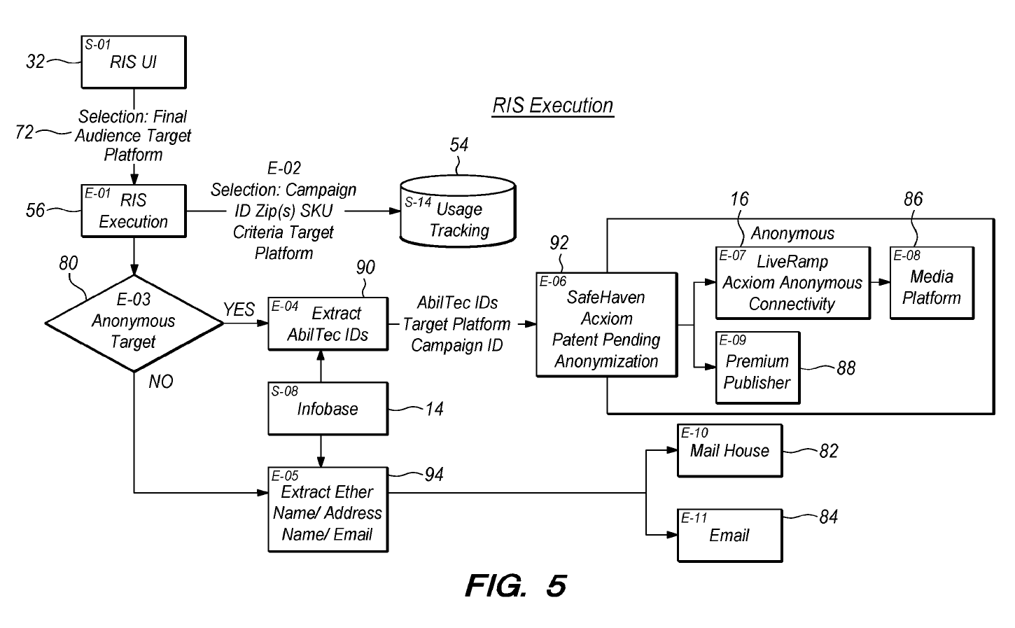

The data flow for RIS execution step 56 is shown in FIG. 5. The RIS UI 32 will first create a new campaign identifier (ID) at campaign ID step 80, and store the campaign ID and the selection criteria for the audience in the usage-tracking database 54. The customer then selects the target platform using RIS UI 32. The target platform provides targeting that falls into two general categories, “known” targeting and “anonymous” targeting. This determination is made by the customer through RIS UI 32 at anonymous targeting decision step 80. Known targeting is the situation in which the RIS and the target platform will know the PII information related to the targeted consumers. The primary targets for known targeting campaigns are traditional mail house 82 and email marketing 84 campaigns. In these types of campaigns, use of PII is allowed, and often the data is provided by the customer itself. For anonymous targeting, which occurs when the target platform does not have the PII for the targeted consumers, the main categories are media platforms 86 via either the onboarding platform 16 or a premium publisher 88. For most types of electronic messaging, and information based on on-line presence, use of PII is not allowed according to applicable laws, regulations, and industry best practices.

In the case of anonymous targeting, the unique identifying “links” for each of the associated customers are extracted from the comprehensive consumer database 14 at anonymous extracting step 90. These links are persistent and unique across the universe of all consumers in comprehensive consumer database 14. A system for creating and maintaining these types of identifying links is shown, for example, in U.S. Pat. Nos. 6,523,041 and 6,766,327, each of which is incorporated by reference herein in its entirety. The extracted links and the campaign ID are then transmitted to the data service provider's anonymized data storehouse 92. Here, all known files are converted to anonymous files, i.e., files that contain no PII. The links that are incorporated into the data are anonymized, such as with any of many common hashing techniques well known in the art, to produce anonymous hashed identifiers (AshIDs). Because of the techniques used to perform the conversion, the conversion is one-way and cannot be reversed. Thus the links from which the AshIDs are created cannot be recovered from knowing the AshIDs. As a result, it may be seen that no PII is contained in anonymized data storehouse 92. After this conversion, the anonymous file will be routed to either the onboarding platform 16 and then the selected media platform 86, or to a premium publisher 88. A “premium” publisher is a publisher of digital content that is generally well known and which is sought out by on-line viewers due to the high quality of its content and their brand equity, such as, for example, Facebook, Google, and Yahoo. In the case of known targeting, the name, address, and email for the consumers, based on the audience criteria, will be extracted from comprehensive consumer database 14 at known extracting step 94. This data is then transmitted to the traditional mail house 82 or the email service provider 84 in order to begin the campaign.

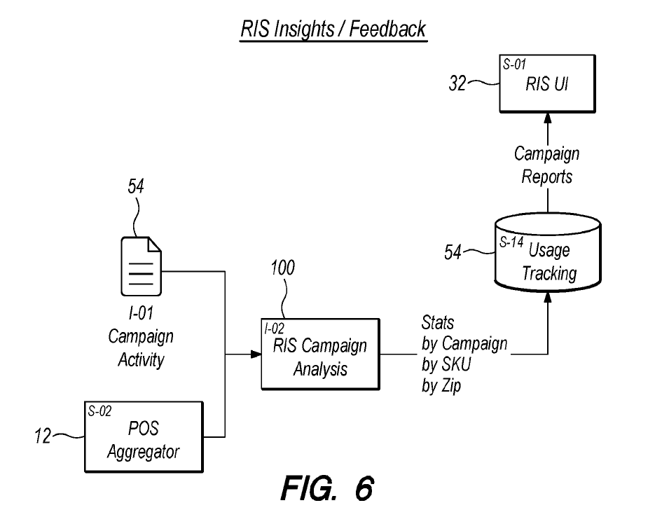

Referring now to the data flow of FIG. 6, the method of providing insights and/or feedback after the campaign may be explained in greater detail. Campaign activity 46 (also referred to herein as audience activity) is used with data from POS aggregator 12 to perform RIS campaign analysis step 100. This analysis consists of two parts. First, prior-period sales in a target ZIP code are compared with post-period sales to capture the incremental impact of the campaign. Dividing the incremental impact in sales by the average sale price of the target SKU gives the number of consumers who responded. Second, campaign analytics available from premium publishers are available when the campaign's spend amount exceeds the publisher's minimum threshold. As an optional additional step, deep campaign analysis can be performed by campaign analytics experts. The result of this analysis includes statistics by campaign, by SKU, and by ZIP code. This data is stored in usage tracking database 54, and is available through campaign reports presented to the customer through RIS UI 32. The result is a “feedback loop” so that each campaign may be built based on results from the previous campaign(s).

Referring to the process flow of FIG. 7, processing that occurs at POS aggregator 12 may be described in more detail. POS aggregator 12 continuously collects sales information. This information can be used to compare the difference in sales before the campaign and after the campaign for the given ZIP codes and product SKUs. Also, the data from ZIP codes not in the campaign can be compared to ZIP codes within the campaign. SKU data 50 examples shown in FIGS. 4 and 7 illustrate the types of data collected at POS aggregator 12 for each item sold. RIS UI 32 allows the customer (retailer, etc.) to see rollup information from the campaign activity and from the POS aggregator 12. The “rollup information” includes summary results from multiple campaigns brought together to provide a total marketing return on investment (MROI) or campaign MROI. This allows the customer to see the lift (i.e., the improvement in sales) that the campaign achieved, which can be fed back into the next campaign.

SKU data 50 feeds to data loading and matching step 110, which readies the data for further processing. At auto matching step 112, data is stored and aligned based one of the attributes associated with the data. At exception resolution and dictionary management step 114, the data is examined to determine if there are values for any of the fields that are outside of acceptable parameters, such as an invalid SKU or a store code that is not contained within a dictionary of store codes maintained by the provider of POS aggregator 12. At data review/quality control (QC) step 116, the data is reviewed to determine if there are any missing segments or obvious problems in the data received. At data closeout step 118, various data “hygiene” steps are performed, such as standardization of the data and de-duplication for further processing.

At raw data checks step 120, the raw data is readied for POS projection step 122. At suppression step 124, data is removed that is on any lists of data that cannot be used. At finished data checks step 126, the final data is checked for any remaining errors, and fed to deliverable generation step 128. The result is decision key file 130 and flat file (or custom-format file) 132, which is used for processing by the user of the POS aggregator 12 services, such as the data services provider. Deliverable validation step 134 is the final quality check before the data file is delivered.

As can be seen from the foregoing discussion, the invention results in substantial efficiencies in the performance of the hardware/software systems utilizing the invention. Processing speed and efficiency is substantially improved by utilizing syndicator data, audience propensity data, and comprehensive consumer data in a single system. This allows marketing, merchandising, and finance organizations to envision, execute, and measure campaign results in one place, thus reducing siloed decision-making. It also allows for decisions to be achieved through faster processing, which results in much more timely retail insights and action i.e., fast enough to capture quickly moving marketing trends.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. When a grouping is used herein, all individual members of the group and all combinations and subcombinations possible of the group are intended to be individually included. When a range is stated herein, the range is intended to include all subranges and individual points within the range. All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention, as set forth in the appended claims.

1. A method for targeting a message at a geographic level, the method comprising the steps of:
a. at a marketing services provider server, receiving from a provider server point-of-sale (POS) data, wherein the POS data comprises a plurality of sales and an association between each sale and a geographic area in which the sale was made;
b. at the marketing services provider server, integrating the POS data with propensity data from a consumer database to create a set of audience data, wherein the consumer database comprises a substantially comprehensive collection of data for consumers in a region of interest;
c. at an offline-to-online server in communication with the marketing services provider server, performing offline-to-online matching with the audience data wherein the audience data is augmented with online contact information for members of the audience; and
d. creating a targeted message directed to members of the audience.

2. The method of claim 1, wherein the sales data in the POS data relates to one or both of consumer packaged goods (CPG) or retail general merchandise.

3. The method of claim 1, wherein the POS data further comprises, for each sale, an associated stock-keeping unit (SKU).

4. The method of claim 1, wherein the geographic area is an area associated with a postal code.

5. The method of claim 4, wherein the postal code is a ZIP code.

6. The method of claim 1, wherein the geographic area is an area sufficiently broad to prevent the identification of a single, individual consumer with the geographic area.

7. The method of claim 1, wherein the provider server is a data syndication server.

8. The method of claim 7, further comprising the step of, prior to receiving the POS data at the marketing services provider server, combining sales data from multiple retailers at the data syndication server.

9. The method of claim 1, wherein the propensity data comprises data indicative of a consumer's interest in a particular category of products.

10. The method of claim 1, wherein the propensity data comprises data indicative of a consumer being in-market for a particular category of products.

11. The method of claim 1, further comprising the steps of:
a. sending the targeted message to each member of the audience;
b. after sending the targeted message to each member of the audience, again receiving point-of-sale (POS) data at the marketing services provider server; and
c. measuring the results from the targeted message sent to the audience.

12. The method of claim 11, further comprising the step of updating the propensity data in the consumer database based on the measurement of the results from the targeted message sent to each member of the audience.

13. The method of claim 12, further comprising the steps of:
a. at the marketing services provider server, again receiving point-of-sale (POS) data;
b. integrating the POS data with the updated propensity data to create a set of updated audience data;
c. performing offline-to-online matching with the updated audience data; and
d. creating a follow-up targeted message directed to members of the audience from the updated audience data.

14. The method of claim 4, further comprising the step of sending the targeted message to each member of the audience, wherein each member of the audience resides within the geographic area associated with the postal code.

15. The method of claim 1, wherein the step of integrating the POS data with propensity data from a consumer database to create a set of audience data comprises the steps of:
a. identifying a subset of data in the consumer database matching a particular geographic area; and
b. further identifying a sub-subset of the data in the consumer database matching a particular geographic area which also matches a desired propensity.

16. A retail insights solution, comprising:
a. a partner company server;
b. a point-of-sale (POS) database in communication with the partner company server, wherein the POS database comprises sales data associating sales with a geographic area in which the sale occurred;
c. a marketing services provider server comprising a software front-end configured to receive a POS data file from the partner company server comprising data from the POS database;
d. a consumer database in communication with the marketing services provider, wherein the consumer database comprises a plurality of records, each record comprising identifying data pertaining to a particular consumer, a geographical area pertaining to such particular consumer, and propensity data pertaining to such particular consumer;
e. an onboarding service server in communication with the marketing services provider server; and
f. an onboarding data base in communication with the onboarding services server comprising a plurality of records each associating offline consumer data with online consumer data;
wherein the marketing services provider server is configured to construct a targeted audience portrait utilizing the consumer database and the POS data file, wherein the targeted audience portrait comprises consumers in the geographic area, and wherein the onboarding service server is configured to construct a marketing message utilizing the targeted audience portrait.

17. The system of claim 16, wherein the marketing services provider software front-end is configured to prevent any leakage of identifying data pertaining to a particular consumer between the consumer database and the partner company server.

18. The system of claim 16, wherein the partner company server is configured to convert retailer divisional trade areas into corresponding postal codes.

19. The system of claim 16, wherein the marketing services provider server is further configured to send the marketing message to consumers through at least one on-line channel.

20. The system of claim 19, wherein the marketing services provider is further configured to remove all personally identifiable information (PII) from the targeted audience portrait prior to constructing the marketing message.

21. The system of claim 20, further comprising an anonymized database in communication with the marketing services provider server and configured to store the targeted audience portrait, wherein no PII is present in the anonymized database.

22. The system of claim 21, wherein the targeted audience portrait further comprises a plurality of anonymized links each associated with a consumer but from which it is not possible to determine the identity of the associated consumer.

23. The system of claim 16, wherein the marketing services provider server further comprises a marketing insights user interface (UI) configured to output a return on investment (ROI) for the marketing message.

24. The system of claim 16, wherein the marketing services provider server is further configured to receive a user token to authenticate a user, allowing browsing of and selection of POS data by one or both of a product code or the geographic area, and record the selection of POS data.

25. The system of claim 24, wherein the geographic area is a postal code, and the marketing services provider is further configured to receive one of the postal codes and one of the propensity codes to construct the targeted audience portrait.

26. The system of claim 25, wherein the marketing services provider is further configured to filter the targeted audience portrait by a secondary attribute.
